(19) United States
(12) Patent Application Publication
(10) Pub. No.: US 2009/0087819 A1
(43) Pub. Date: Apr. 2, 2009

(54) Information Providing System for Meal Management

(75) Inventors: Yukihiko Adachi, Mie (JP); Masahiko Kakiuchi, Mie (JP); Kazuko Iwata, Mie (JP); Susumu Imai, Tokyo (JP); Masanori Takai, Tokyo (JP); Tetsuya Kaneko, Tokyo (JP)

Correspondence Address: KANESAKA BERNER AND PARTNERS LLP, 1700 DIAGONAL RD, SUITE 310, ALEXANDRIA, VA, 22314-2848, US

(73) Assignee: SHOEI PRINTING CO., LTD., Chuo-ku (JP)

(21) Appl. No.: 11/922,401

(22) PCT Filed: Dec. 22, 2005
(86) PCT No.: PCT/JP2005/023665

§ 371 Date: Jun. 5, 2008

(30) Foreign Application Priority Data
Jun. 24, 2005 (JP) 2005-184796

(51) Int. Cl. G09B 19/00

(52) U.S. Cl. 434/127

(57) ABSTRACT

Meal menu data suitable for each patient is created as a combination of a plurality of types of meal according to the symptom, actual condition, or preference and provided to the patient or alliance restaurants. An information processing system for meal management comprises medical institution network servers interconnected through a bidirectional information communication network, restaurant servers, patient data processors, and a center server. The center server includes meal restriction information storage means for storing meal restriction information created according to electronic medical record information on each patient provided from the medical institution network server for each patient ID number, means for creating meal menu information served in the restaurants corresponding to the electronic medical record information or the meal restriction information on the patient according to the meal restriction information for each patient ID number and means for distributing the meal menu information to the restaurant servers and the patient data processors through the bidirectional information communication network.

### TECHNICAL FIELD

The present invention relates to information processing and an information providing system for meal management. In particular, the present invention relates to an information providing system for providing menu information for a meal management or meal restriction according to a person (patient) who is having ingestion of the number of ingestion calories, a specific nutrient or a mineral, etc. restricted.

### BACKGROUND ART

In recent years, in particular, in advanced nations, the diabetes said as a lifestyle-related disease or geriatric diseases by the excess of the calorie ingestion by a meal and the hypertension by high lipoid have resulted in the spreading situation. The diabetic patient number is said at least for the inside of Japan to be over 6,500,000 people. The reserve of the diabetic who suffers from a glucose tolerance obstacle is called population of one per ten. Furthermore, the person of the hyperlipemia or the hypertension by the excess of calorie ingestion is said to be over one per five person of an adult. Moreover, for people who suffer from an impaired liver function or renal dysfunction, ingestion of specific minerals, such as iron and calcium, may be restricted, for example. Furthermore, specific cooking ingredients, such as an egg, may be unable to be taken in for allergy.

As a result of the medical examination in a hospital, a health center, etc., or a health examination, the people of the patient who suffers from these lifestyle-related diseases or geriatric diseases, or its reserve will need to restrict the calorie taken in a daily meal, will need to avoid ingestion of specific nutritive elements, minerals (hereinafter, refer to generically as “nutritive elements”), or a cooking ingredient, or will need to restrict to below the specified quantity.

The case where the number of calories is displayed on a menu for every meal provided in the restaurant chain etc. which provide the limited menu for the people who need such a meal restriction, or the people who care about overweight can see now.

Moreover, in the dining room in a university hospital and the comparatively great hospital which a public institution found, the meal according to the symptom for every patient, or the medicinal kind and amount to take may be provided based on a medical record. This will not be possible without the medical care department and meal providing department in the same hospital sharing the data for every patient.

### DISCLOSURE OF THE INVENTION

### Problem to be Solved by the Invention

However, for the people who restrict ingestion of caloric restriction or specific nutritive elements although it is not in the hospital, it cannot but control itself in a daily meal. However, the contents of these meal restrictions are of infinite variety according to the physiques and constitutions, such as the person's height and weight, the amount of mean motion per day, the grade of the symptom of the hypertension, hyperlipemia, or diabetes, etc. from which the person suffers. For example, even if the number of ingestion calories of the specific meal had become clear in a home and a restaurant, a hotel, dining room, etc. (hereinafter, refer to generically as “restaurant”) which provide a meal, self-control of meal management suffered a setback from it being troublesome and being difficult in many cases.

For this reason, an aim of the present invention is: to provide the information providing system for creating the menu information for every patient for the meal management and the meal restriction based on the symptom, the actual condition, or the preference of each patient for the people of the patient who suffers from a lifestyle-related disease or geriatric diseases, or its reserve, people who need to restrict ingestion of specific nutritive elements to below the specified quantity, or people who care about overweight (in this application, these people are referred to generically as “patient”); and to providing the information providing system for the meal restriction which provides each patient, an alliance restaurant, etc. with the menu information concerned; under the current condition where the development of communications networks, such as the Internet, and the spread of the personal computer and cellular phone which can access this, and the IC card, magnetic cards, etc. which stored personal information, and the environment in a hospital, such as electronization of a medical record (utilization of an electronic medical record), is being improved.

### Means for Solving Problem

To achieve the above objects, the present invention provides an information process system for meal management comprises two or more medical institution network servers, two or more restaurant servers, two or more patient data processors, and a center server, interconnected through a bidirectional information communication network, wherein said center server includes: meal restriction information storage means for storing meal restriction information created based on each patient's electronic medical record information provided from said medical institution network server for every patient ID number of each patient; means for creating meal menu information provided at said two or more restaurants corresponding to the electronic medical record information or meal restriction information of the patient concerned based on said meal restriction information for every patient ID number; and means for distributing said meal menu information to said two or more restaurant servers and said two or more patient data processors through said bidirectional information communication network.

Said center server further includes a general cooking data memory means which stores menu information related to general home cooking, and said meal menu information includes the menu information related to the home cooking stored in the concerned general cooking data memory means.

And, said center server is connected to one or more cooking school network servers, and the menu information related to the home cooking stored in said general cooking data memory means is received from the cooking school network servers concerned. Thereby, it is possible to add not only the menu information provided by the specific restaurant but the menu information of home cooking to the menu information which can be provided.

By the way, said meal restriction information of each patient provided from said medical institution network server is created in view of the grade of each patient's disease state, the physique and constitutions, such as height and weight, and the amount of mean motion per day with which the patient concerned is burdened. Moreover, since said center server associates preference data of each patient's meal or cooking ingredient sent from said patient data processor with said patient ID number as a preference code to store, it is possible to provide the meal menu suited each patient's preference. Therefore, said center server creates said meal menu information created for every patient ID number based on said preference code and said meal restriction information of the patient concerned.

Moreover, said meal menu information includes at least a name of a meal, the number of calories of the meal concerned, the amount of one or more specific nutritive elements included in the meal concerned, and recipe information of the meal concerned. And then, said meal menu information is created as a combination of two or more kinds of meals for every patient.

By the way, as for people who suffer from an impaired liver function or renal dysfunction, since ingestion of specific minerals, such as iron and calcium, may be restricted, in order to correspond to this, said meal menu information includes the information about the specific nutritive elements or cooking ingredient in which the patient concerned has to avoid ingestion.

In addition, said patient data processors are a personal computer, a portable communication terminal or a cellular phone, connectable with said bidirectional information communication network (for example, the Internet).

### EFFECT OF THE INVENTION

Thereby, the present invention realized creating the suitable for meal menu information which suited the symptom, the actual condition, or the preference for every patient as a combination of two or more kinds of meals for the people of the patient who suffers from a lifestyle-related disease or geriatric diseases, or its reserve, the people who need to restrict ingestion of specific nutritive elements to below the specified quantity, or the people (patient) who care about overweight, based on the medical record information or meal limitation information from a medical institution etc., such as a university, and providing a patient individual and an alliance restaurant etc. with this system.

### BRIEF DESCRIPTION OF THE DRAWINGS

FIG. 1 is an outline chart showing an entire configuration of information processing and an information providing system related to this embodiment;

FIG. 2 describes the contents of data and information which communicates mutually a center server, and network servers C, D, E, and F, and a patient data processor B, in the information processing and the information providing system related to this embodiment;

FIG. 3 is an explanatory diagram explaining a menu print facility of the information processing and the information providing system related to this embodiment;

FIG. 4 is a block diagram showing the system configuration of a menu printing job as a subject of the information processing and the information providing system related to this embodiment;

FIG. 5 is a block diagram showing a system configuration including a connection between the center server and a medical institution network server of the information processing and the information providing system related to this embodiment;

FIG. 6 is an explanatory diagram showing data exchanged and its flow between the center server and a medical institution network server of the information processing and the information providing system related to this embodiment;

FIG. 7 is a block diagram showing a system configuration including a connection between the center server and a patient data processor of the information processing and the information providing system related to this embodiment;

FIG. 8 is an explanatory diagram showing data exchanged and its flow between the center server and the patient data processor of the information processing and the information providing system related to this embodiment;

FIG. 9 is a block diagram showing a system configuration including a connection between the center server and a printing company network server of the information processing and the information providing system related to this embodiment;

FIG. 10 is an explanatory diagram showing data exchanged and its flow between the center server and the printing company network server of the information processing and the information providing system related to this embodiment;

FIG. 11 is a block diagram showing a system configuration including a connection between the center server and a general user's data processing apparatus of the information processing and the information providing system related to this embodiment;

FIG. 12 is an explanatory diagram showing data exchanged and its flow between the center server and the general user's data processing apparatus of the information processing and the information providing system related to this embodiment;

FIG. 13 shows a concrete example of a hardware configuration of the center server in the information processing and the information providing system related to this embodiment with a block diagram;

FIG. 14 shows an example of a search screen (restricted diet menu search screen) for accessing meal menu information for every patient stored in a menu information memory means;

FIG. 15 shows an example of restricted diet personal information which a medical institution authorized personnel involved in membership can browse;

FIG. 16 shows an example of restricted diet personal information which a restaurant authorized personnel involved in membership can browse;

FIG. 17 shows an example of restricted diet personal information which a food company authorized personnel or a drug company authorized personnel involved in membership can browse;

FIG. 18 shows an example of a cover in the case of being created as a combination of two or more kinds of meals for every patient;

FIG. 19 shows a first example of a meal menu executed by a hard copy is in this system;

FIG. 20 shows a second example of a meal menu executed by a hard copy is in this system; and

FIG. 21 shows a third example of a meal menu executed by a hard copy is in this system.

### EXPLANATIONS OF LETTERS OR NUMERALS

A: Center server (Center DB server)
B: Patient data processor
C: Medical institution network server
D: Restaurant network server
E1: Cooking ingredient information providing server (food company network server)
E2: Drug company network server
E3: Medical device maker network server
F: Printing company network server
10: Digital service unit
11: Web server
12: FTP server
13: DNS server
14: SSL server
15: D/B server
16: I/F unit
17: Control server
18: Meal limitation information D/B (Meal limitation information storage means)
19: Menu data D/B (Menu data storage means)
20: Cooking ingredient data D/B (Cooking ingredient data storage means)
21: Menu information D/B (Menu information memory means)

### DESCRIPTION OF THE PREFERRED EMBODIMENT(S)

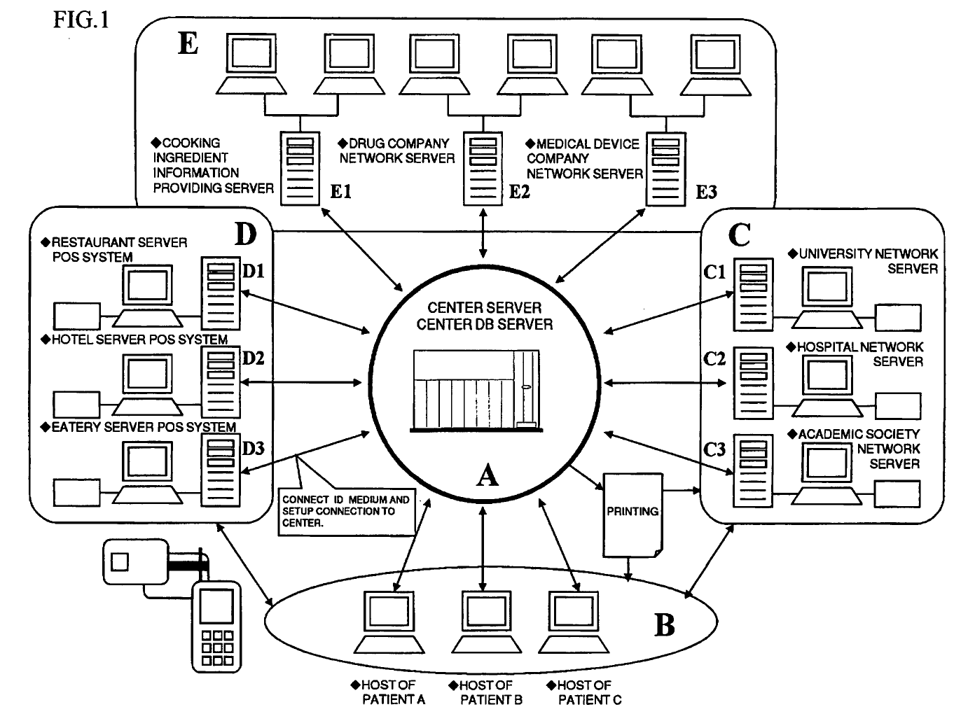

FIG. 1 is an outline chart showing the entire configuration of an information processing and an information providing system related to this embodiment. As shown in FIG. 1, a center server (center DB server) A which is an operational site for creating and providing meal menu information for a meal restriction is connected with two or more medical institution network servers, such as a university network server C1, a hospital network server C2, and an academic society network server C3, and is connected with two or more restaurant servers, such as a restaurant server (POS system) D1, a hotel server D2, and an eatery server D3, respectively, through bidirectional information communication networks, such as the Internet and a private telecommunication line.

The center server (center DB server) A in this operational site is connected to further a cooking ingredient information providing server E1 established by a food company etc. for providing a restaurant with various cooking ingredients, a drug company network server E2, and a medical device maker network server E3.

The center server (center DB server) A in this operational site is connected with further two or more patients' patient data processor B. This patient data processor B may be a portable communication terminal or a cellular phone besides a personal computer connectable with a bidirectional information communication network.

Thereby, as explained in detail later, the center server A in this operational site obtains each patient's electronic medical record information or meal limitation information from two or more medical institution network servers C1, C2, and C3. The center server A creates the meal menu information provided at said two or more restaurants corresponding to the electronic medical record information or the meal limitation information of the patient concerned for every patient ID number, based on this obtained data. (Furthermore, the center server A obtains the menu information for every meal from the restaurant server D1, the hotel server D2, and the eatery server D3 with the cooking ingredient component data of the meal concerned, and obtains the number of calories per unit quantity of each cooking ingredient, the nutritive elements included in each food, and its volume from the cooking ingredient information providing server E1. The center server A can also create the meal menu information provided at said two or more restaurants corresponding to the electronic medical record information or the meal limitation information of the patient concerned for every patient ID number based on these data.)

Moreover, the center server A may be connected to a cooking school network server (not shown), and may obtain the menu information related to general home cooking.

In addition, various kinds of the network servers C, D, E, and F, and the patient data processor B connected to the center server A belong to the membership organization registered beforehand. Data and information, which communicate mutually are enciphered and various kinds of the network servers C, D, E, and F, and the patient data processor B are composed accessible by collation of the registered password. Moreover, the membership patient's electronic medical record information or meal limitation information provided from the medical institution network server C1, C2, and C3 is managed strictly, and has provided restrictions on access by executing an editing process when providing for the restaurant server, such as the restaurant server (POS system) D1, the hotel server D2, or the eatery server D3, as mentioned later.

The bidirectional communication network used in FIG. 1 is a loose coupling type communication network, such as Transmission Control Protocol/Internet Protocol (TCP/IP), an intranet, the Internet, and an extra network, for example. And, the form of provision of information utilizes EDI relevant systems, such as a Web Service. This center server (center DB server) A is built by the technology of a Relational Data Base (RDB) or an XML database. Moreover, the data stored in each database by using the application developed by JAVA (registered trademark) or C language is extracted by SQL etc. The data output system is based on HTML or XML, and is browsed through a browser.

Furthermore, a communication line is connected with the network system in consideration of security, such as a dedicated line or VPN.

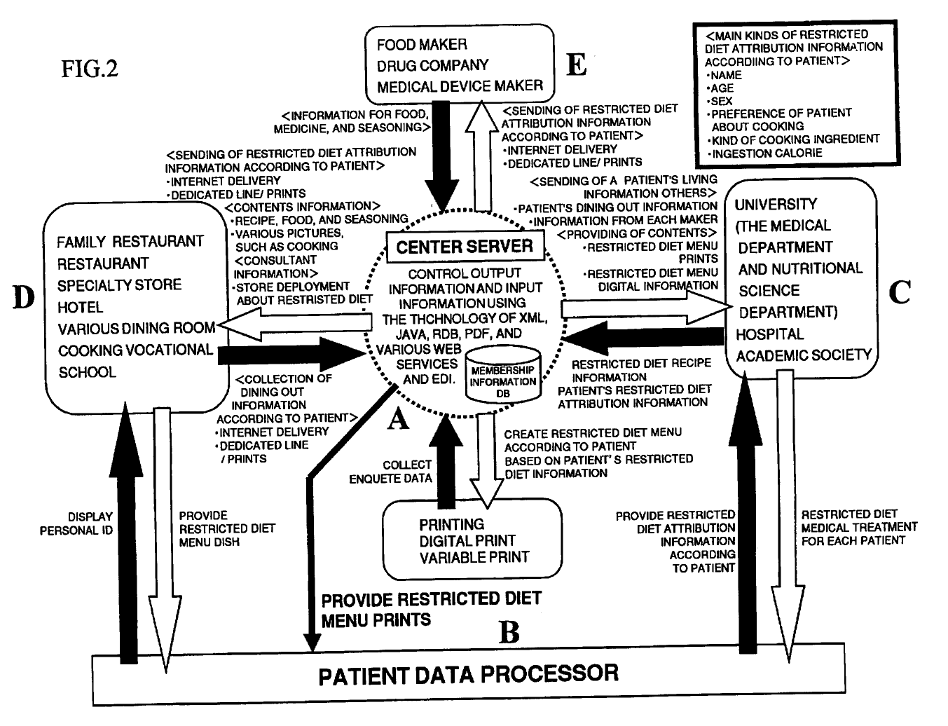

FIG. 2 describes the contents of the data and information which communicates mutually the center server A, the network server C, D, E, and F, and the patient data processor B, in the information processing and the information providing system related to this embodiment. The outline of mutual communication data etc. is as follows.

### (1) From the Center Server A to the Patient Data Communication Device B

a) Display a restricted diet menu information for every patient.

b) A patient individual browses related information, such as a recipe about personal information or restricted diet, via the communication network system by using each data processing apparatus B.

### (2) From the Patient Data Communication Device B to the Medical Institution Data Server C

a) Collect various questionnaire information.

b) Send the question about questionnaire information or related matters.

### (3) From the Center Server A to the Patient Data Communication Device B

a) Display the dining out information according to patient individual.

b) Edit the collected information into information required for medical services, and display it. The patient information, such as medical examination information and a clinical history, may be merged with the server in a medical institution.

### (4) From the Medical Institution Network Server C to the Center Server A

a) Collect the restricted diet information according to patient individual.

b) Collect the personal information relevant to restricted diet among medical examination information. Moreover, a patient's taste, the required intake of each component, etc. are obtained.

### (5) From the Center Server A to the Restaurant Server D

a) Display the restricted diet menu information according to patient individual.

b) Display the information about a patient individual's restricted diet, food information from a food company or a drug company-related company, seasoning information, and restricted diet recipe information, etc.

### (6) From the Restaurant Server D to the Center Server A

a) Collect the dining out information according to patient individual, an using menu, and using seasonings.

b) Collect a patient's information and the adoption information on a seasoning and food collected in a restaurant, a hotel, each eatery, etc.

### (7) From the Center Server A to the Cooking Ingredient Information Providing Server E1

a) Display utilizable situations (popular ranking etc.), such as a seasoning, food, etc. about a restricted diet menu.

b) Display the result of the field test of the food in a restaurant or a home, and the new product about the utilizable situation of a seasoning and restricted diet, and other related information. However, patient's personal information is not displayed.

### (8) From the Cooking Ingredient Information Providing Server E1 to the Center Server A

a) Collect information on new products, such as a seasoning, food, etc. about a meal menu.

b) Perform provision of information, such as food and a seasoning. The field test (enquete is included) of a new product may be requested.

### (9) Providing of the Print Data of Meal Menu Information

a) Edit the meal menu information for every patient into variable print format data, print it, and provide to patient data processor B.

b) Provide a patient with the variable print format data of the meal menu information for every patient through the medical institution network server C.

### (10) Other Processes

The ID cards (an ID card, a magnetic card, a bar code card, a cellular phone, etc.) owned by each patient are utilized to communicate from a restaurant, a hotel, and other eateries to the center server A. It connects with the center server through a patient's ID medium on account of security. (It connects through a POS terminal, each media reader, and a host computer in a restaurant, a hotel, and other eateries by using PKI).

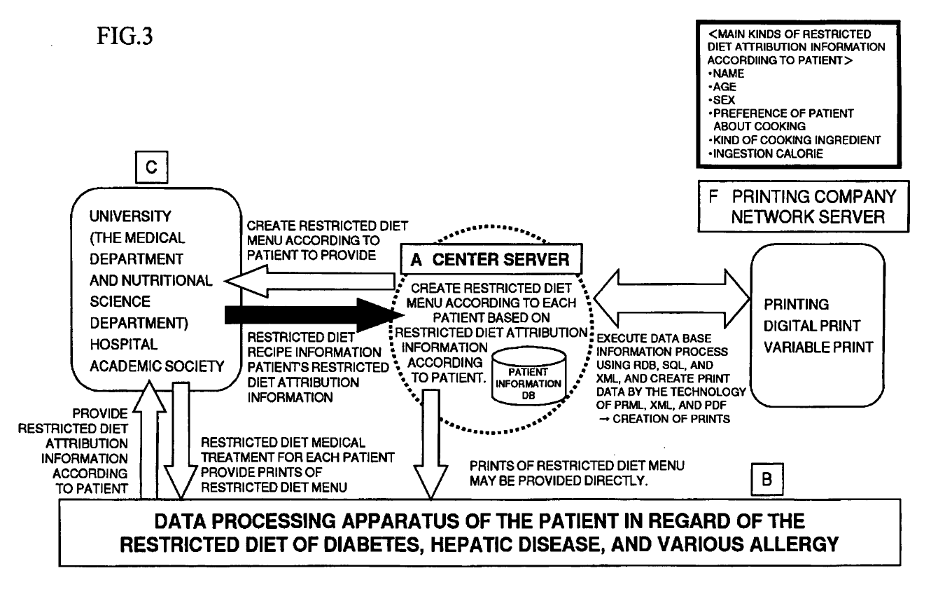

FIG. 3 is an explanatory diagram explaining the information processing and the menu print facility of the information providing system, related to this embodiment. As shown in FIG. 3, the restricted diet attribution information according to patient is sent to the center server A from the patient data processor B.

Although the center server A obtains restricted diet recipe information and said patient's restricted diet attribution information from the medical institution network server C and creates the restricted diet menu according to each patient based on this information, this printing operation is entrusted to the printing company network server F when printing this restricted diet menu.

Said restricted diet attribution information according to patient includes a patient's name, a patient's age, a patient's sex, a patient's dish preference, the kind of cooking ingredient suitable for a patient, the ingestion calorie that a patient should protect, etc.

The information on said restricted diet menu created in the center server A is sent to the medical institution network server C. Moreover, the information on said restricted diet menu is sent also to the data processing apparatus B of the concerned patient directly or through the medical institution network server C from the center server A, or the prints printed said restricted diet menu are sent to the addressing to the patient concerned.

Hereafter, a system configuration of the information processing and the information providing system related to this embodiment will be explained.

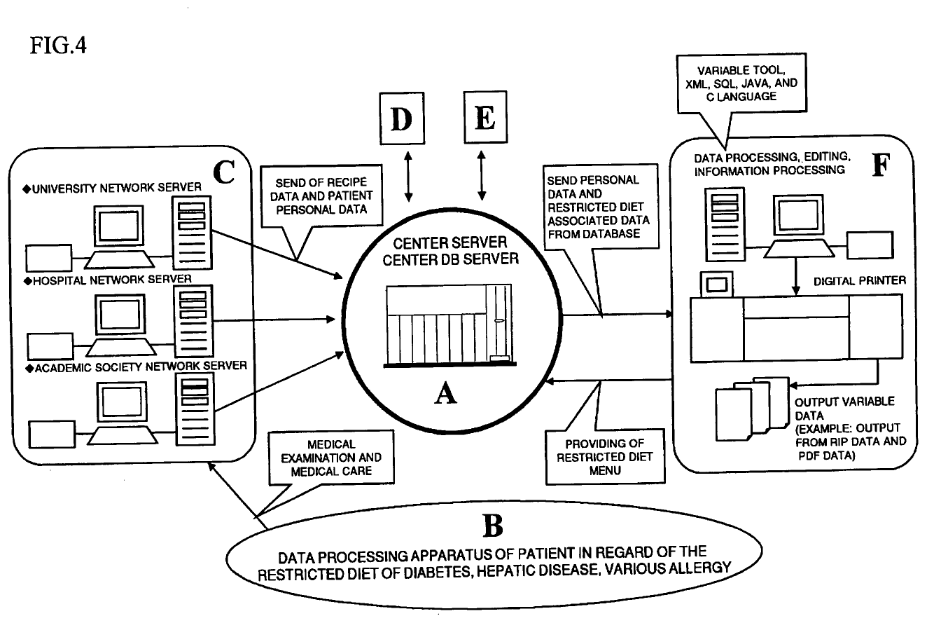

FIG. 4 is a block diagram showing a system configuration composed the menu printing job as the subject of the information processing and the information providing system related to this embodiment. The center server A obtains and manages information including patient's personal data, nutritive elements of a cooking ingredient about restricted diet, and a calorie and a cooking method, collected through the medical period server C etc. through the information network.

About said collected information, the center server A executes processing of data and a design process, and creates the individual restricted diet menu data according to a patient individual, and sends the collected personal data and restricted diet associated data of the patient to the printing company network server F to entrust printing of a restricted diet menu. From printing company network server F received this, the information on the printed restricted diet menu is sent to the center server A.

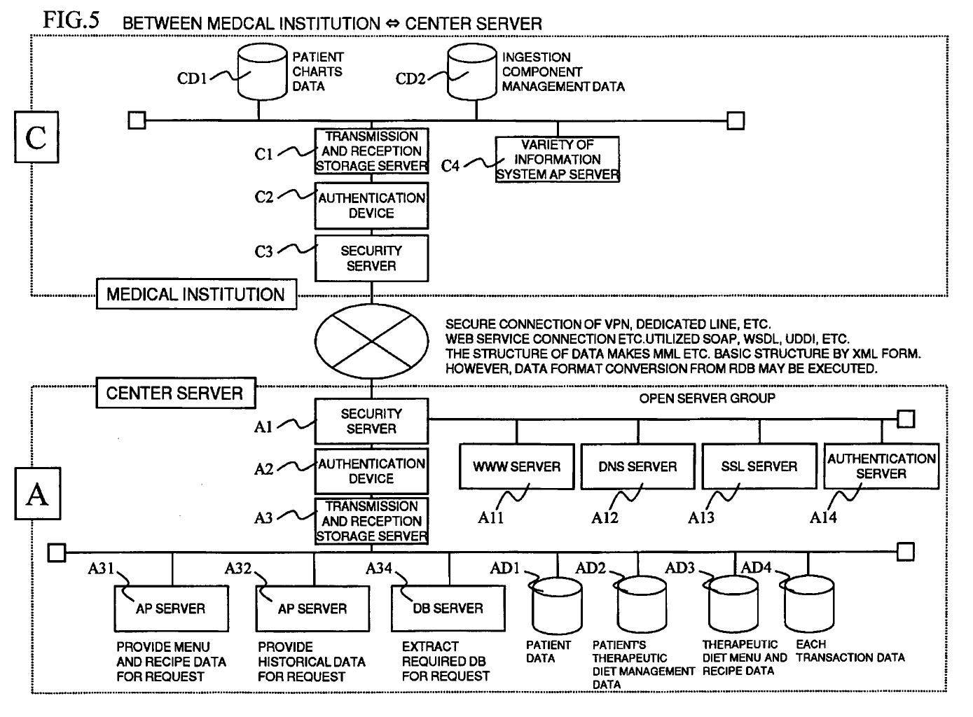

FIG. 5 is a block diagram showing a system configuration including a connection between the center server and the medical institution network server of the information processing and the information providing system related to this embodiment. As shown in FIG. 5, between the center server A and the medical institution network server C is connected in the information and communications network including the Internet network etc. This information and communications network includes a network which utilized SOAP, WSDL, UDDI, etc. in which the web service connection is possible, besides the network in which the secure connection, such as a VPN, a dedicated line, is possible. A structure of the data, which communicates in this network is based on MML etc. by XML form. Moreover, a data format conversion from RDB may be executed.

As a component of a system function level, the center server A includes and composed with a security server A1, an authentication device A2, and a transmission and reception storage server A3. Moreover, the center server A includes a WWW server A11, a DNS server A12, an SSL server A13, and an authentication server A14, which the security server A1 have jurisdiction over. Furthermore, the center server A includes AP servers A31 and A32, a DB server A34, a database AD1, AD2, AD3, and AD4, managed by the transmission and reception storage server A3.

The security server A1 of the center server A is connected with the above-mentioned information network.

The WWW server A11 manages the web page to publish. The DNS server A12 is used for a Domain Name System (DNS). The SSL server A13 initiates an encryption communication protocol. The authentication server authenticates a communications partner. The security server A1, which has jurisdiction over these is connected to the transmission and reception storage server A3 through the authentication device A2 which authenticates a hardware stage, in the latter stage, and can communicate with the medical institution network server C.

The AP server A31 managed by the transmission and reception storage server A3 provides above-mentioned restricted diet menu data and recipe data for the request from each access points (patient data processor etc.). Moreover, the AP server A31 provides the patient's historical data for the request from each access point. Furthermore, the DB server A34 searches a database required for access to information and extracts required information according to the request from each access point.

Moreover, the database AD1 managed by the transmission and reception storage server A3 stores the patient's personal data, the database AD2 stores the patient's therapeutic diet management data, the database AD3 stores the patient's therapeutic diet menu and recipe data, and the database AD4 stores transaction file data (various relevant file data by which batch processing should be executed for every patient, such as account data).

The medical institution network server C includes a transmission and reception storage server C11, an authentication device C12, a security server C13, and an each information system AP server VC4, as a component of a system function level. Moreover, a database CD1 managed by the transmission and reception storage server C11 stores the patient's medical record data, and a database CD2 stores the patient's therapeutic diet's ingestion component management data.

The security server C13 of the medical institution network server C is connected with the above-mentioned information network, and can communicate with the center server A.

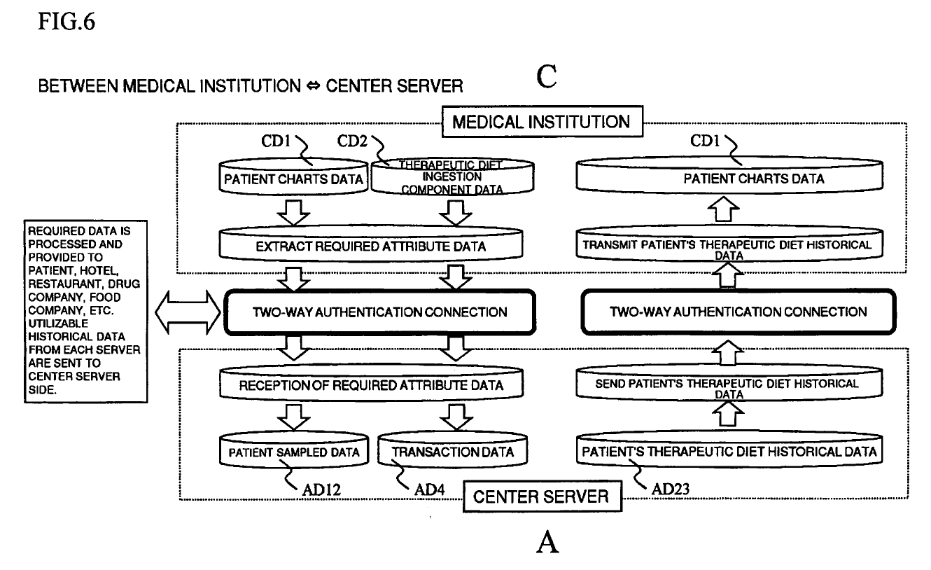

FIG. 6 is an explanatory diagram showing the data exchanged and its flow between the center server of information processing and the information providing system related to this embodiment and the medical institution network server. As shown in FIG. 6, the center server A includes a database AD12 storing the memory contents (patient sampled data) of the above-mentioned database AD1 and database AD2, and further includes a database AD23 storing the memory content (patient's therapeutic diet historical data) of the above-mentioned data pace AD2 and database AD3, besides the database AD4 storing the above-mentioned transaction data.

On the other hand, the medical institution network server C includes the above-mentioned database CD1 (patient charts data) and the database CD2 (therapeutic diet's ingestion component data).

The memory contents of the database CD1 (patient charts data) of the medical institution network server C and the database CD2 (therapeutic diet ingestion component data) is sent to the center server A, after the two-way authentication connection between the medical institution network server C and the center server A is executed, and is stored in the database AD12 (patient sampled data) and the database AD4 (transaction data). Moreover, After the two-way authentication connection between the center server A and the medical institution network server C is executed, the memory contents of the database AD23 of the center server A is sent to the medical institution network server C, and updates the database CD1.

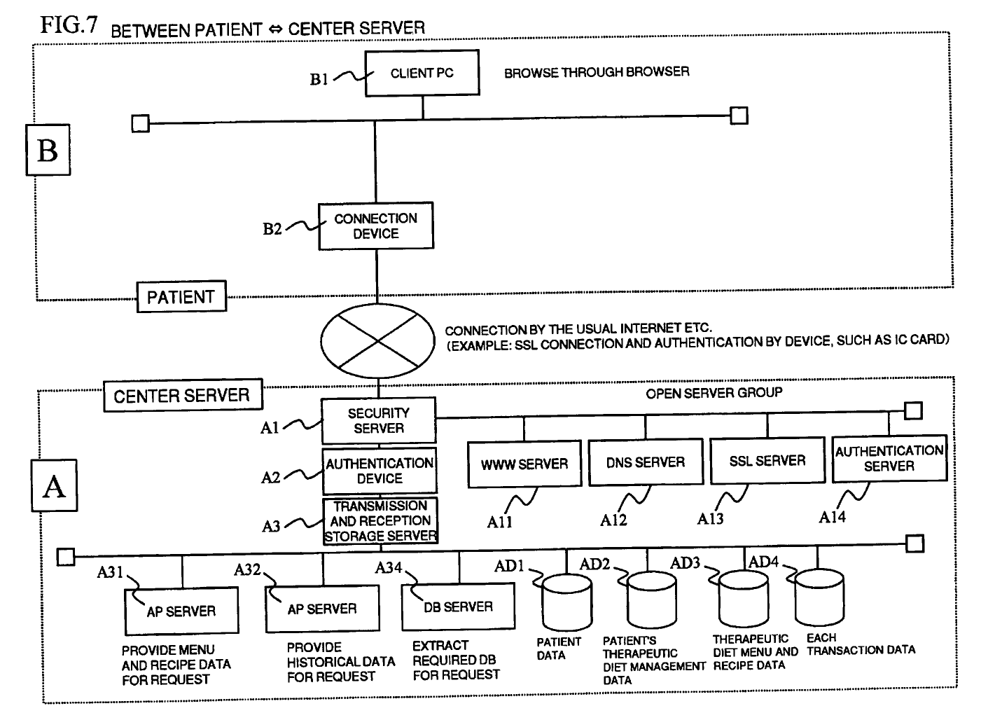

FIG. 7 is a block diagram showing a system configuration including a connection between the center server and the patient data processor of the information processing and the information providing system related to this embodiment. As shown in FIG. 7, at least a client PC (B1) and a connection device B2, which executes a connection with the above-mentioned information network (however, Internet network subject) shall be installed in the patient data processor B. The system configuration of the center server A is as above-mentioned (refer to FIG. 5).

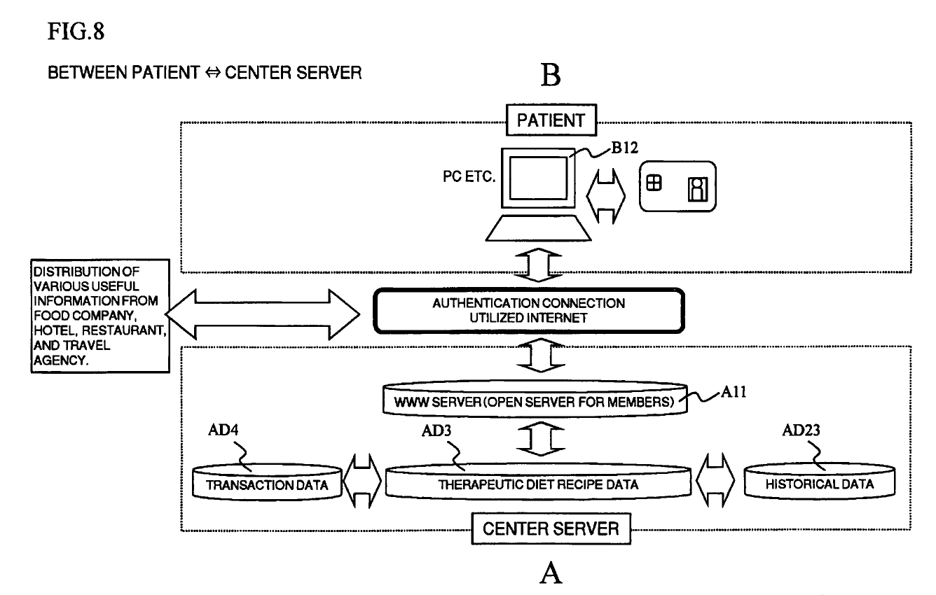

FIG. 8 is an explanatory diagram showing the data exchanged and its flow between the center server and the patient data processor of the information processing and the information providing system related to this embodiment. As shown in FIG. 8, authentication connection using an Internet network is executed between terminal units B12 (IC card, various mobile terminals, PC, etc.) which have at least above-mentioned client PC (B1) and the connection device B2, and the center server A. It is exchanged in data among both after this authentication.

A patient performs the above-mentioned authentication connection between the center server A and the terminal unit B12, and accesses the center server A, from a house etc. After this connection, the patient can receive the recipe of a therapeutic diet required for the patient individual from the center server A, and can browse it on the terminal unit B12. Moreover, the patient sends self historical data to the center server A, and makes it record on the above-mentioned database AD23 (patient's therapeutic diet historical data).

In the center server A, above-mentioned database AD4 (transaction data) and the above-mentioned database AD23 (patient care meal history data) are consolidated as the database AD3 (therapeutic diet recipe data), and it publishes to a member through the WWW server A11 as web information (web page information) towards the member.

When said patient is an accounting object, account data is recorded on the above-mentioned database AD4 (transaction data).

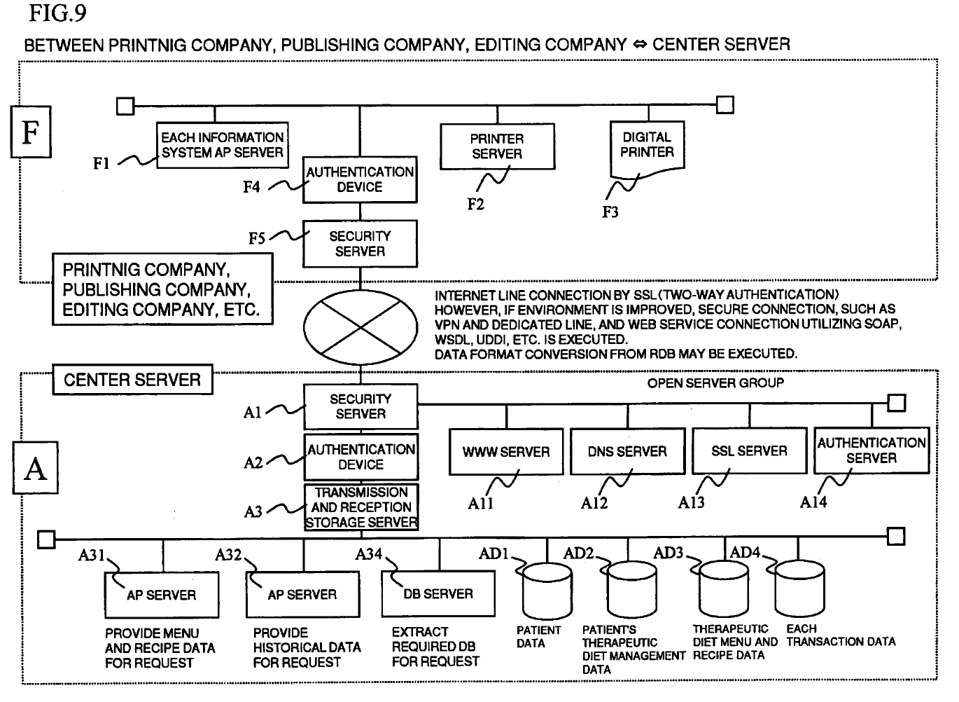

FIG. 9 is a block diagram showing a system configuration including a connection between the center server and the printing company network server of the information processing and the information providing system related to this embodiment. As shown in FIG. 9, the printing company network server F includes and is composed with an each information system AP server F1, a printer server F2, a digital printer F3, an authentication device F4, and a security server F5.

The system configuration of center server A is as above-mentioned (refer to FIG. 5).

The line connection to the Internet network according to SSL (two-way authentication) is a subject about the connection aspect of the information network which can be used between the printing company network server F and the center server A. However, if environment is improved, the web service connection etc. utilized secure connection, such as VPN, a dedicated line, and SOAP, WSDL, UDDI, etc. is possible. Moreover, it is also possible to execute data format conversion from RDB.

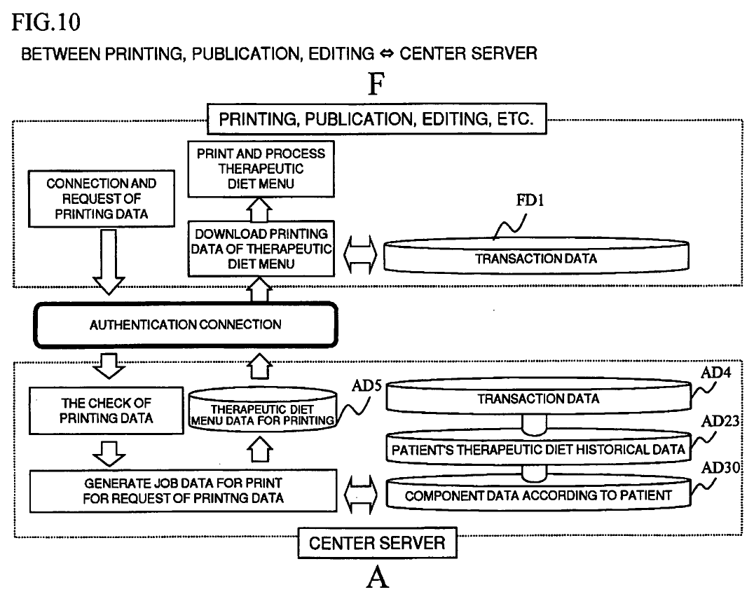

FIG. 10 is an explanatory diagram showing the data exchanged and its flow between the center server and the printing company network server of the information processing and the information providing system related to this embodiment. Between the center server A and the printing company network server F shown in FIG. 10, the agreement about entrusting printing of a therapeutic diet menu is performed beforehand. Therefore, as shown in the same Fig., from the printing company network server F, the line connection for the center server A is executed, and printing data are requested.

The center server A received this creates job data for a print corresponding to this request, after checking the request of said printing data. At the time of this creation, the component data according to patient is extracted and referred to from the database 30, which stores the data created based on the above-mentioned database AD4 (transaction data) and the database AD23 (patient's therapeutic diet historical data).

When the job data for a print are created, the database AD5 once stores as data for a therapeutic diet menu print, and this data for a therapeutic diet menu print is further sent to the printing company network server F. In the printing company network server F, this data for the therapeutic diet menu print is received, the therapeutic diet menu is printed based on the memory contents of this data and the database FD1 (transaction data), and it is processed it if needed.

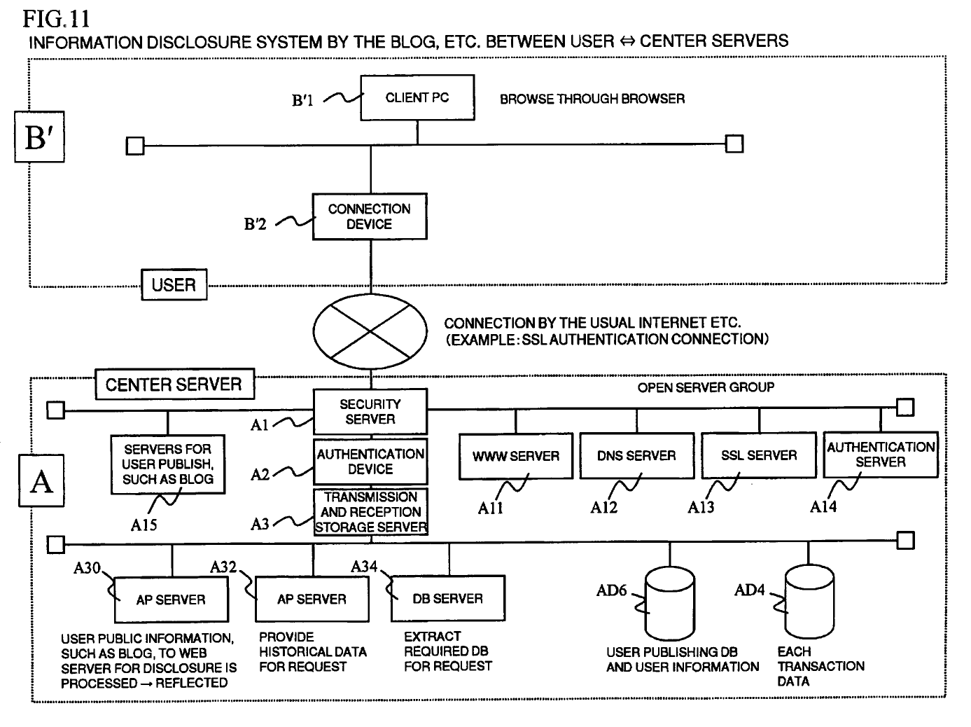

FIG. 11 is a block diagram showing a system configuration including a connection between the center server and a general user's data processing apparatus of the information processing and the information providing system related to this embodiment. As shown in FIG. 11, at least a client PC (B′1) and a connection device B′2 which executes a connection with the above-mentioned information network (however, Internet network subject) shall be installed in the general user's (potential customer who is not necessarily a patient) data processing apparatus B′. The system configuration of center server A is as above-mentioned (refer to FIG. 5).

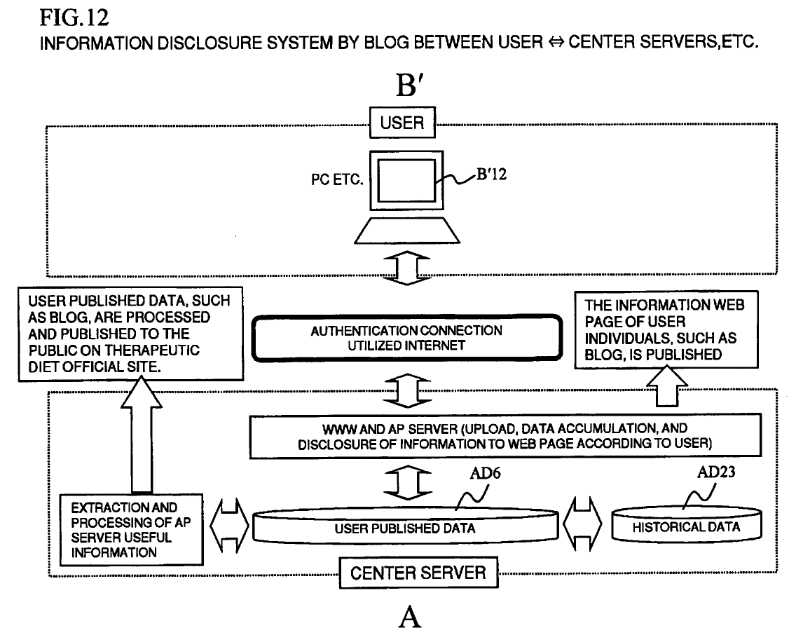

FIG. 12 is an explanatory diagram showing the data exchanged and its flow between the center server and the general user's data processing apparatus of the information processing and the information providing system related to this embodiment. As shown in FIG. 12, the authentication connection using an Internet network is executed between at least of the above-mentioned terminal unit B′12 (IC card, various mobile terminals, PC, etc.), the client PC (B′1) and the connection device B′2, and the center server A. The data is exchanged between both after this authentication.

A general user performs the above-mentioned authentication connection between the center server A and the terminal unit B′12, and accesses the center server A from a house etc. After this connection, this general user can send the data in which the self knowledge etc. about therapeutic diet, a new recipe, etc. were shown to the center server A, and can store it in the database AD6 (user published data) and the database AD23 (history day evening). The center server A publishes this data on user personal web pages, such as a blog. Moreover, after acquiring the approval of said general user beforehand, the center server A performs a total and a treatment process to publish useful information for a patient etc. among this data on therapeutic diet official sites, such as a blog, managed by the center server A.

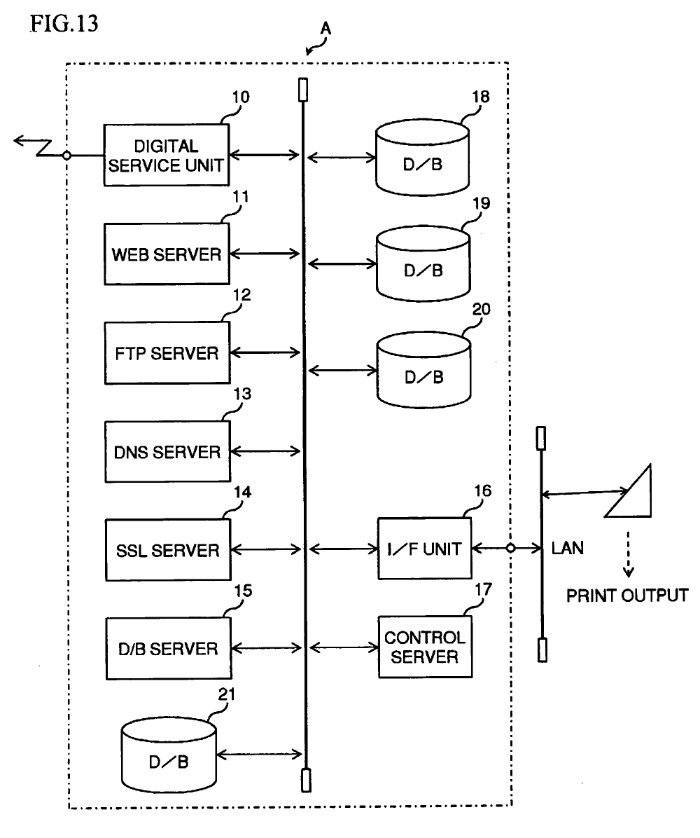

FIG. 13 shows a concrete example of a hardware configuration of the center server in the information processing and the information providing system related to this embodiment with a block diagram. In FIG. 13, the center server A includes a digital service unit 10 mounting a Digital Service Unit (DSU) for connecting with Integrated Services Digital Network (ISDN) 1A, and a router etc. (not shown) mounting firewall application for the prevention from invasion, and an Web server 11 for executing the communications processing on the Internet.

Furthermore, this center server A includes an FTP server 12 for File Transfer Protocol (FTP) file transfers, a DNS server 13 for Domain Name System (DSN), and a Secure Sockets Layer (SSL) server 14. This SSL server 14 is an object for initiating of the encryption communication protocol for data transfer in various kinds of data or providing of information. This center server A includes a D/B server 15 for database (D/B) device control, and an interface (I/F) circuit 16 in which an external LAN is accommodated.

Furthermore, a control server 17 for controlling these each part is provided in the operated site communication device 4. This control server 17 includes a drive device (not shown) for reading and installing a program for executing a various data process from CD-ROM etc.

And, the center server A includes two or more following databases for storing various kinds of data.

(1) A meal limitation information D/B 18 for storing each patient's electronic medical record information or meal limitation information provided from the medical institution network server C for every patient ID number of each patient. Here, each patient's meal limitation information provided from this medical institution network server C is created in view of the grade of each patient's disease state, the physique and constitutions, such as height and weight, and the amount of mean motion per day with which the patient concerned is burdened.
(2) A menu data D/B 19 for storing the menu information for every meal provided from the restaurant server D with the cooking ingredient component data of the meal concerned.
(3) A cooking ingredient data storage means 20 for storing the number of calories per unit quantity of each cooking ingredient provided from the cooking ingredient information providing server E1, and two or more nutritive elements included in each cooking ingredient and the volume of those.
(4) A menu information D/B21 for storing the meal menu information for every patient ID number.

Here, each patient's meal or the preference data of a cooking ingredient is associated with said patient ID number as a preference code, and stored it. Said meal menu information created for every patient ID number is created based on said preference code, at least of the restricted diet recipe information and the patient's restricted diet attribution information from the medical institution server A.

And, this meal menu information includes at least of the name of a meal, the number of calories of the meal concerned, the amount of one or more specific nutritive elements included in the meal concerned, and the recipe information of the meal concerned. Furthermore, this meal menu information is created as a combination of two or more kinds of meals for every patient, and is stored.

Furthermore, this meal menu information includes the information about the specific nutritive elements or cooking ingredient in which the patient concerned has to avoid ingestion.

Moreover, this center server A may include general cooking data memory means (not shown) for storing the menu information related to general home cooking, and said provided meal menu information may be composed so that the menu information related to the home cooking stored in the general cooking data memory means concerned may be included.

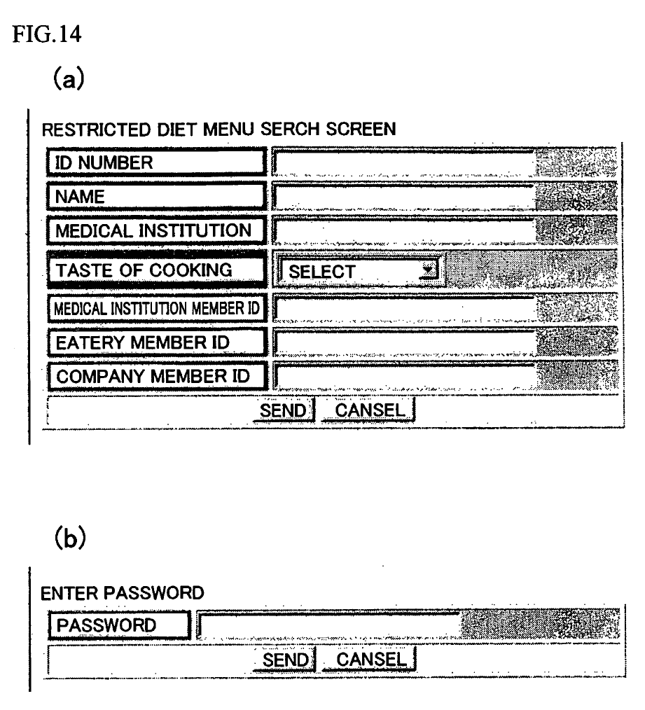

FIG. 14 shows an example of a search screen (restricted diet menu search screen) for accessing the meal menu information for every patient stored in the above-mentioned menu information memory means 21. Since the “restricted diet menu search screen” shown in FIG. 14 (a) will appear if this center server is accessed through the communication network, required data is inputted according to the screen display. In this case, since a “password input screen” as shown in FIG. 14 (b) will appear if an access person inputs the ID number (membership number) registered beforehand, the meal menu information for every patient stored in the menu information memory measure 21 can be obtained by entering the password registered beforehand.

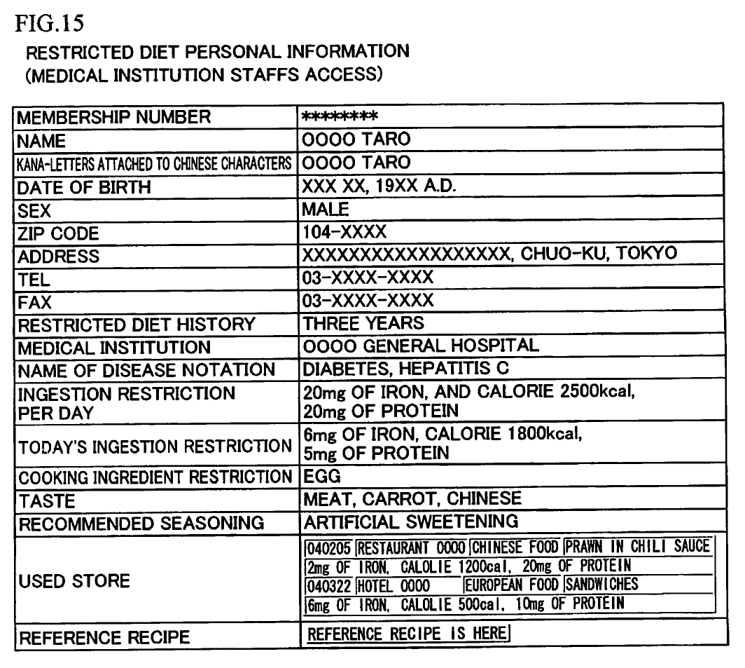

FIG. 15 shows the example of the restricted diet personal information which the medical institution authorized personnel involved in membership can browse. The restricted diet personal information browsed by the medical institution staffs aims at performing medical practice, and can take in the electronic medical record information managed in the hospital. Moreover, a patient's dining out hysteresis information can be browsed.

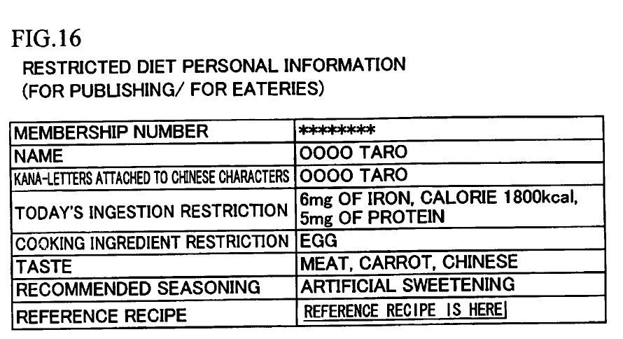

FIG. 16 shows an example of the restricted diet personal information which the restaurant authorized personnel involved in membership can browse. The personal information browsed by the restaurant authorized personnel involved in membership has the aim supported so that it can dine out satisfactorily for a patient individual's restricted diet. The address etc. has applied restrictions on access for the information about personal privacy from a viewpoint of protection of personal information. They are mainly the information about a restricted diet menu, such as a patient individual's name, and the amount of caloric restrictions, and preferences.

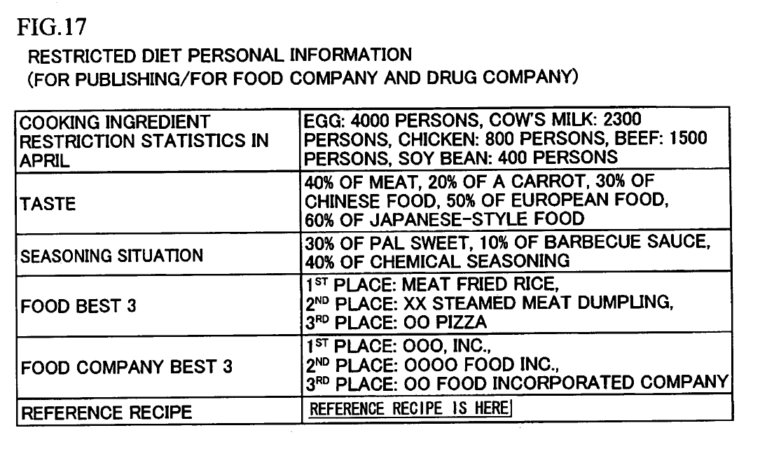

FIG. 17 shows an example of the restricted diet personal information which the food company staffs or the drug company authorized personnel involved in membership can browse. The restricted diet personal information, which the food company authorized personnel involved in membership can browse is information about marketing which took statistics or was analyzed, such as quantitative information and qualitative information. Restrictions on access have applied to the information about a patient individuals' privacy.

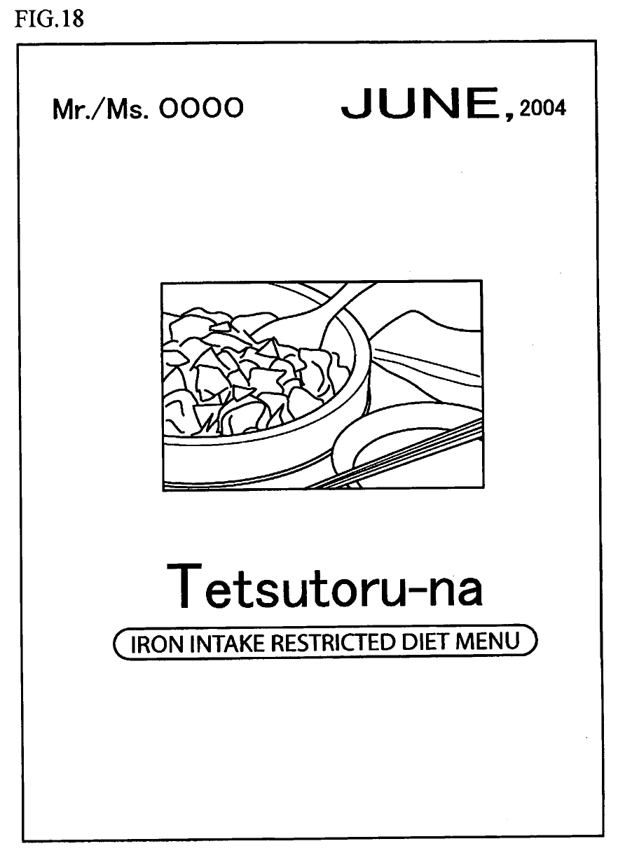

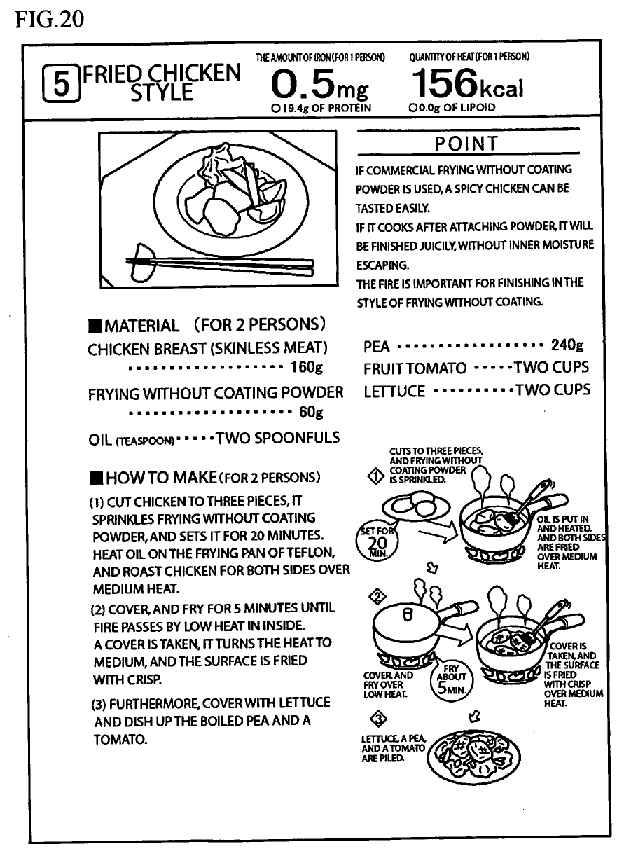

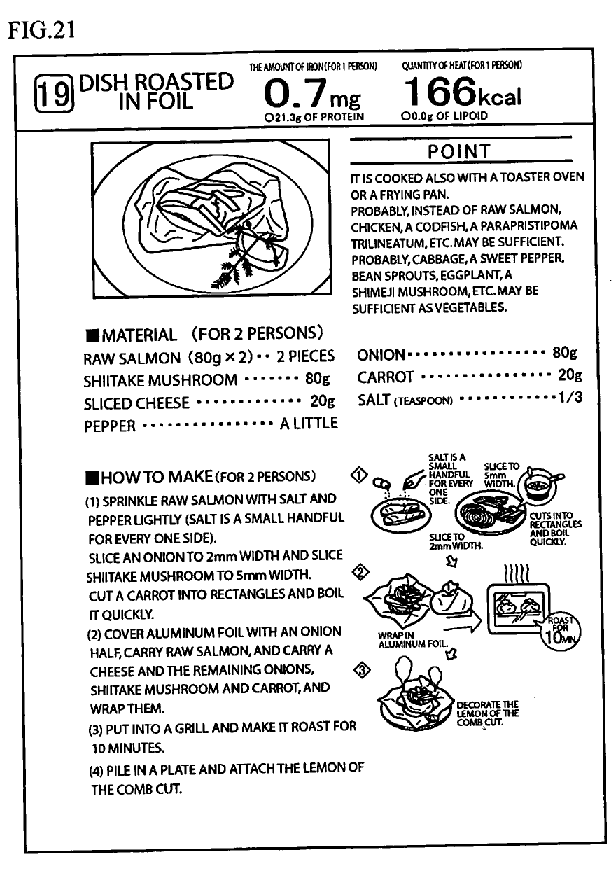

FIGS. 18 to 21 show an example of the actual menu executed the printout of the meal menu information created for every patient ID number.

FIG. 18 shows an example of a cover in the case of being created as a combination of two or more kinds of meals for every patient. This cover is the example which specified a name of patient and “iron” as the nutritive elements or the mineral in which in particular the patient concerned has to restrict ingestion, and was created as an [iron intake restricted diet menu].

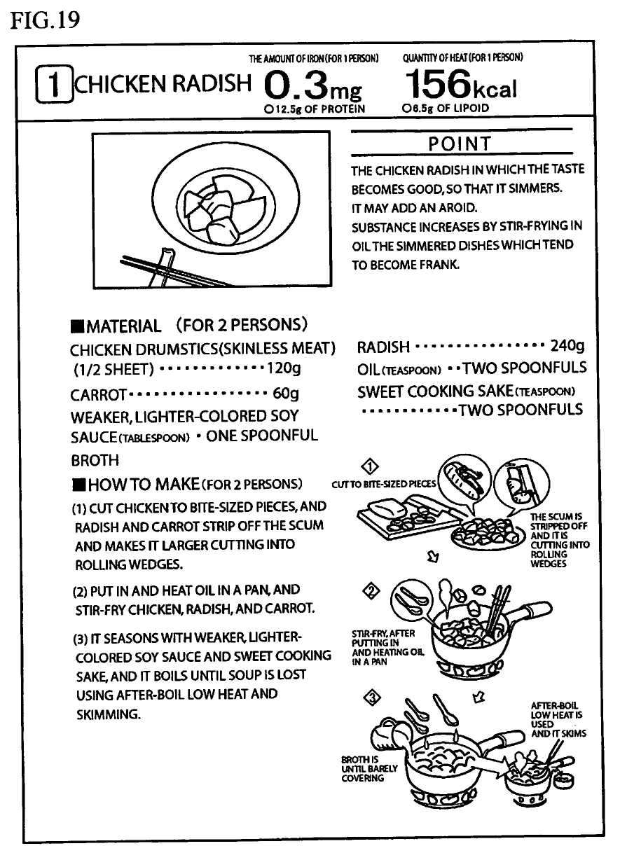

FIGS. 19, 20, and 21 show a description example of the individual menu related to the combination of two or more kinds of meals. Here, the number of calories, an iron content, protein content, fat content, of the menu meal concerned, and the cooking ingredient and requirement for cooking the menu meal concerned and the recipe are displayed with the drawings.

### INDUSTRIAL APPLICABILITY

The present invention relates to an information processing system for meal management. In particular, the present invention relates to information processing and an information providing system for providing menu information according to a person (patient) who is having ingestion of the number of ingestion calories per day, a specific nutrient, etc. restricted, and therefore has industrial applicability.

1. An information process system for meal management comprises two or more medical institution network servers, two or more restaurant servers, two or more patient data processors, and a center server, interconnected through a bidirectional information communication network, wherein
said center server includes:
meal restriction information storage means for storing meal restriction information created based on each patient's electronic medical record information provided from said medical institution network server for every patient ID number of each patient;
means for creating meal menu information provided at said two or more restaurants corresponding to the electronic medical record information or meal restriction information of the patient concerned based on said meal restriction information for every patient ID number; and
means for distributing said meal menu information to said two or more restaurant servers and said two or more patient data processors through said bidirectional information communication network.

2. The information providing system according to claim 1, wherein said center server further includes a general cooking data memory means which stores menu information related to general home cooking, and said meal menu information includes the menu information related to the home cooking stored in the concerned general cooking data memory means.

3. The information providing system according to claim 2, wherein said center server is connected to one or more cooking school network servers, and the menu information related to the home cooking stored in said general cooking data memory means is received from one or more cooking school network servers concerned.

4. The information providing system according to claim 1, wherein said meal restriction information of each patient provided from said medical institution network server is created in view of the grade of each patient's disease state, the physique and constitutions, such as height and weight, and the amount of mean motion per day with which the patient concerned is burdened.

5. The information providing system according to claim 1, wherein said center server associates preference data of each patient's meal or cooking ingredient sent from said patient data processor with said patient ID number as a preference code to store.

6. The information providing system according to claim 5, wherein said center server creates said meal menu information created for every patient ID number based on said preference code and said meal restriction information of the patient concerned.

7. The information providing system according to claim 1, wherein said meal menu information includes at least a name of a meal, the number of calories of the meal concerned, the amount of one or more specific nutritive elements included in the meal concerned, and recipe information of the meal concerned.

8. The information providing system according to claim 7, wherein said meal menu information is created as a combination of two or more kinds of meals for every patient.

9. The information providing system according to claim 7, wherein said meal menu information includes the information about the specific nutritive elements or cooking ingredient in which the patient concerned has to avoid ingestion.

10. The information providing system according to claim 1, wherein said patient data processors are a personal computer, a portable communication terminal or a cellular phone, connectable with said bidirectional information communication network.
